(19) United States
(12) Patent Application Publication
(10) Pub. No.: US 2011/0176631 A1
(43) Pub. Date: Jul. 21, 2011

(54) COMMUNICATION METHOD FOR MIMO COMMUNICATION SYSTEM

(75) Inventors: YUNG SZU TU, HSINCHU COUNTY (TW); CHENG HSUAN WU, HSINCHU COUNTY (TW); YEN CHIN LIAO, HSINCHU COUNTY (TW)

(73) Assignee: RALINK TECHNOLOGY CORPORATION, HSINCHU COUNTY (TW)

(21) Appl. No.: 13/006,173

(22) Filed: Jan. 13, 2011

Related U.S. Application Data
(60) Provisional application No. 61/296,131, filed on Jan. 19, 2010.

(51) Int. Cl. H04B 7/02

(52) U.S. Cl. 375/267

(57) ABSTRACT

A communication method for a MIMO communication system comprises the steps of: transmitting a plurality of first streams modulated in a non space division multiplexing manner from a transmitter to a plurality of receiving stations; and transmitting a plurality of second streams following the plurality of first streams modulated in a space division multiplexing manner from the transmitter to the plurality of receiving stations. Each of the first streams comprises a legacy short training field, a legacy long training field, a legacy signal field and at least a very high throughput signal field, and each of the first streams has the same length. Each of the second streams comprises a very high throughput short training field, a plurality of very high throughput long training fields and a data field, and each of the second streams has the same length.

### BACKGROUND OF THE INVENTION

1. Field of the Invention

The present invention relates to a communication system, and more particularly, to a communication method for a MIMO communication system.

2. Description of the Related Art

Wireless local area network (WLAN) technology is widely established to provide access to the Internet with mobile devices. To improve the throughput of a WLAN, IEEE 802.11n standard adopts a multiple-input-multiple-output (MIMO) system that transmits a plurality of streams with multiple antennas and, at the same time, receives a plurality of streams with multiple antennas. However, IEEE 802.11n is still a point-to-point transmission scheme. When there are more stations connected to the access point (AP), each station has to hold the transmission and wait for an empty time slot.

Therefore, a multi-station (MU) transmission system with MIMO system is proposed. A MU-MIMO system can simultaneously transmit data to multiple stations from a single antenna or multiple antennas, such that more stations can be served by the AP at the same time. The Physical Layer Convergence Procedure protocol (PLCP) data unit (PPDU) format used in MU-MIMO system is designed to provide backward compatibility with IEEE 802.11a/g/n devices in the 5 GHz frequency band. Meanwhile, the PPDU format shall also provide the mechanism by which the access point can transmit signals to multiple stations simultaneously and can also receive signals from multiple stations at the same time.

### SUMMARY OF THE INVENTION

The invention presents a method for a MU-MIMO system such that the MU-MIMO system is backward compatible with IEEE 802.11a/g/n devices in the 5 GHz frequency band.

The communication method for a MIMO communication system according to one embodiment of the present invention comprises the steps of: transmitting a plurality of first streams modulated in a non space division multiplexing manner from a transmitter to a plurality of receiving stations; and transmitting a plurality of second streams following the plurality of first streams modulated in a space division multiplexing manner from the transmitter to the plurality of receiving stations. Each of the first streams comprises a legacy short training field, a legacy long training field, a legacy signal field and at least a very high throughput signal field. The first streams are all of the same length. Each of the second streams comprises a very high throughput short training field, a plurality of very high throughput long training fields and a data field. The second streams are all of the same length.

The communication method for a MIMO communication system according to another embodiment of the present invention comprises the steps of: transmitting a plurality of first streams modulated in a non space division multiplexing manner from a transmitter to a plurality of receiving stations; and transmitting a plurality of second streams following the plurality of first streams modulated in a space division multiplexing manner from the transmitter to the plurality of receiving stations. Each of the first streams comprises a legacy short training field, a legacy long training field, a legacy signal field and at least a first very high throughput signal field. The first streams are all of the same length. Each of the second streams comprises a very high throughput short training field, a plurality of very high throughput long training fields, a second very high throughput signal field and a data field. All of the second streams pertaining to the same receiving station are of the same length.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes as those of the present invention. It should also be realized by those skilled in the art that such to equivalent constructions do not depart from the spirit and scope of the invention as set forth in the appended claims.

### BRIEF DESCRIPTION OF THE DRAWINGS

The objectives and advantages of the present invention will become apparent upon reading the following description and upon referring to the accompanying drawings of which:

FIG. 1 shows the flowchart of a communication method for a MIMO communication system according to an embodiment of the present invention;

FIG. 2 shows a format of a stream used by the communication method for a MIMO communication system according to an embodiment of the present invention;

FIG. 3 shows the flowchart of a communication method for a MIMO communication system according to another embodiment of the present invention; and

FIG. 4 shows a format of a stream used by the communication method for a MIMO communication system according to another embodiment of the present invention.

### DETAILED DESCRIPTION OF THE INVENTION

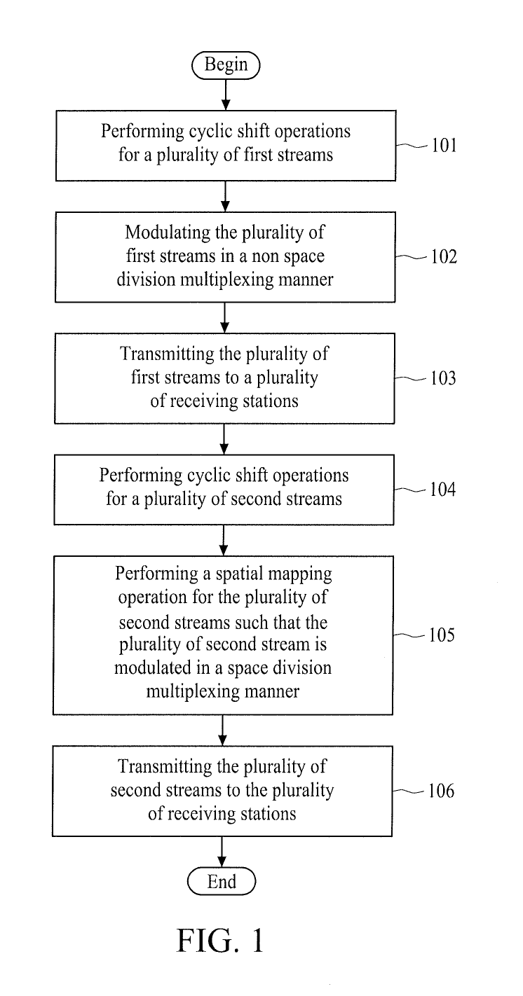

FIG. 1 shows the flowchart of a communication method for a MIMO communication system according to an embodiment of the present invention. In step 101, cyclic shift operations are performed for a plurality of first streams, and step 102 is executed. In step 102, the plurality of first streams are modulated in a non space division multiplexing manner, and step 103 is executed. In step 103, the plurality of first streams are transmitted to a plurality of receiving stations, and step 104 is executed. In step 104, cyclic shift operations are performed for a plurality of second streams, and step 105 is executed. In step 105, a spatial mapping operation is performed for the plurality of second streams such that the plurality of second streams are modulated in a space division multiplexing manner, and step 106 is executed. In step 106, the plurality of second streams are transmitted to the plurality of receiving stations, and the present communication method is finished.

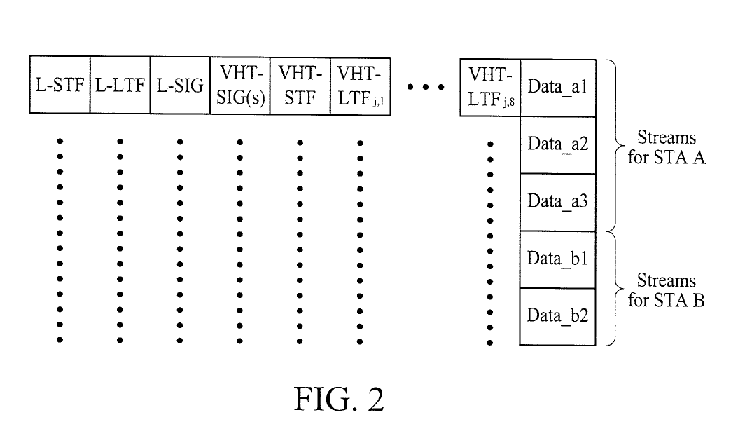

FIG. 2 shows a format of a plurality of streams used by the communication method shown in FIG. 1. In a MU-MIMO system, a transmitter, such as an access point (AP), can transmit a plurality of streams to a plurality of receivers, such as stations, at the same time. Taking the plurality of streams shown in FIG. 2 for example, the transmitter (not shown) transmits three streams to station A (STA A) and two streams to station B (STA B). Accordingly, the number of antennas at the transmitter is five or more, the number of antennas at station A is three or more, and the number of antennas at station B is two or more. Please note that the number of streams and the numbers of antennas are exemplary and should not be construed as a limitation to the present invention. The format shown in FIG. 2 is used for all the streams. As can be seen from FIG. 2, each of the plurality of streams shown in FIG. 2 can be divided into two parts: a first stream and a second stream.

The first streams comprise a legacy short training field (L-STF), a legacy long training field (L-LTF), a legacy signal field (L-SIG) and at least a very high throughput signal field (VHT-SIG), and each of the first streams has the same length. In this embodiment, as can be seen from FIG. 2, the format of each of the first streams follows the order of the legacy short training field, the legacy long training field, the legacy signal field and the at least one very high throughput signal field. The legacy short training field, a legacy long training field and the legacy signal field are comprised in the first stream such that the plurality of streams shown in FIG. 2 can be backward compatible with IEEE standard 802.11a/g/n.

Further, the second stream comprises a very high throughput short training field (VHT-STF), a plurality of very high throughput long training fields (VHT-LTF) and a data field, and each of the second streams has the same length. In this embodiment, as can be seen from FIG. 2, the format of each of the first streams follows the order of the very high throughput short training field, the plurality of very high throughput long training fields and the data field. The very high throughput short training field and the plurality of very high throughput long training fields are used for channel estimation. For a full estimation of the channels of the MU-MIMO system, the number of the very high throughput long training fields is equal to or greater than the number of the second streams, i.e. the number of the data fields. Since there are five data fields in this embodiment, three for station A and two for station B, the number of very high throughput long training fields is equal to or greater than five, and is eight in this embodiment.

Referring to the method shown in FIG. 1, when the transmitter uses the stream format shown in FIG. 2 to transmit data, cyclic shift operations are first performed for each of the first streams as indicated in step 101, wherein each of the first streams corresponds to a different cyclic shift value. Thereafter, the plurality of first streams are mapped to the antennas at the transmitter as indicated in step 102. Accordingly, the number of first streams is equal to the number of the antennas of the receiving stations. In step 103, the plurality of first streams are transmitted to a plurality of receiving stations. In some embodiments of the present invention, the bandwidth of the first streams can be 20 MHz, 40 MHz, 60 MHz or 80 MHz. If such bandwidth is wider than 20 MHz, the spectrum of each of the first streams is divided into sub-bands of 20 MHz, and each sub-band is a duplicate of other sub-bands with phase rotation.

In step 104, cyclic shift operations are first performed for each of the second streams, wherein each of the second streams corresponds to a different cyclic shift value. In step 105, a spatial mapping operation is performed for the plurality of second streams such that the plurality of second streams are modulated in a space division multiplexing manner. Accordingly, a beam-forming technique is utilized such that the antennas in station A are more likely to receive the three data fields Data_a1, Data_a2 and Data_a3. Likewise, the antennas in station B are more likely to receive the two data fields Data_b1 and Data_b2. In some embodiments of the present invention, the number of second streams is equal to or less than the number of the antennas of the transmitter. Accordingly, the parameter j of the very high throughput long training fields (VHT-LTF) shown in FIG. 2 is less than five. In step 106, the plurality of second streams are transmitted to the plurality of receiving stations. In some embodiments of the present invention, the bandwidth of the second streams can be 20 MHz, 40 MHz, 60 MHz or 80 MHz, and can be contiguous or non-contiguous. In the case of 80 MHz bandwidth, the very high throughput short training field is the 80 MHz version of the legacy short training field.

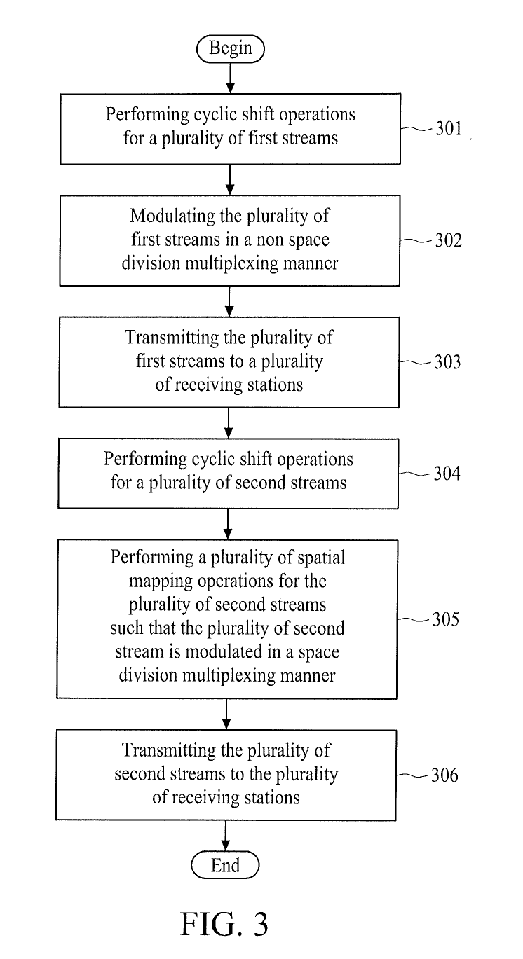

FIG. 3 shows the flowchart of a communication method for a MIMO communication system according to another embodiment of the present invention. In step 301, cyclic shift operations are performed for a plurality of first streams, and step 302 is executed. In step 302, the plurality of first streams are modulated in a non space division multiplexing manner, and step 303 is executed. In step 303, the plurality of first streams are transmitted to a plurality of receiving stations, and step 304 is executed. In step 304, cyclic shift operations are performed for a plurality of second streams, and step 305 is executed. In step 305, a plurality of spatial mapping operations are performed for the plurality of second streams such that the plurality of second streams are modulated in a space division multiplexing manner, and step 306 is executed. In step 306, the plurality of second streams are transmitted to the plurality of receiving stations, and the present communication method is finished.

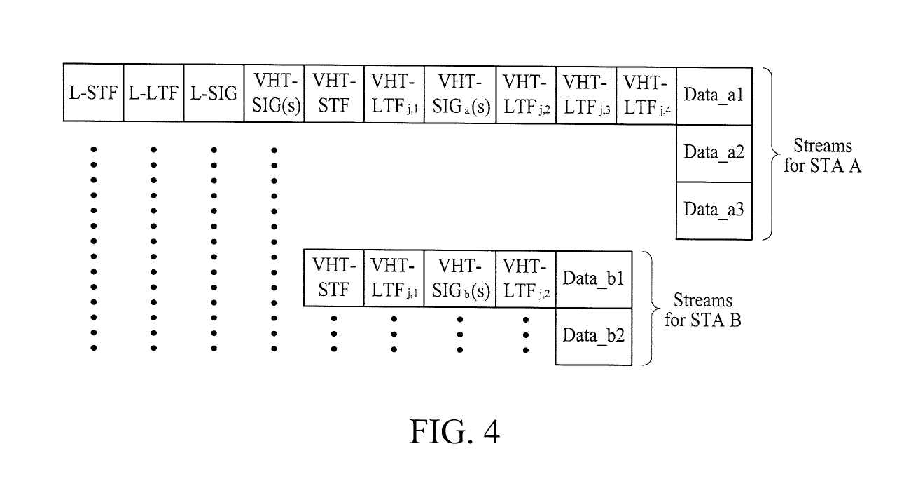

FIG. 4 shows a format of a plurality of streams used by the communication method shown in FIG. 3. Similarly, in a MU-MIMO system, the transmitter (not shown) transmits three streams to station A (STA A) and two streams to station B (STA B). Accordingly, the number of antennas at the transmitter is five or more, the number of antennas at station A is three or more, and the number of antennas at station B is two or more. Please note that the numbers of streams and antennas are exemplary and should not be construed as a limitation to the present invention. The format shown in FIG. 4 is used for all the streams. As can be seen from FIG. 4, each of the plurality of streams shown in FIG. 4 can be divided into two parts: a third stream and a fourth stream.

The third streams comprise a legacy short training field (L-STF), a legacy long training field (L-LTF), a legacy signal field (L-SIG) and at least a first very high throughput signal field (VHT-SIG); the first streams are all of the same length. In this embodiment, as can be seen from FIG. 4, the format of each of the third streams follows the order of the legacy short training field, the legacy long training field, the legacy signal field and the at least one first very high throughput signal field. The legacy short training field, a legacy long training field and the legacy signal field are comprised in the third stream such that the plurality of streams shown in FIG. 4 can be backward compatible with IEEE standard 802.11a/g/n.

Further, the fourth stream comprises a very high throughput short training field (VHT-STF), a plurality of very high throughput long training fields (VHT-LTF), a second very high throughput signal field (VHT-SIGₐ and VHT-SIG_{b}) and a data field. In some embodiments of the present invention, the format of each of the fourth streams follows the order of the very high throughput short training field, the plurality of very high throughput long training fields, the second very high throughput signal field and the data field. In some embodiments of the present invention, the format of each of the second streams follows the order of the very high throughput short training field, the first field of the plurality of very high throughput long training fields, the second very high throughput signal field, the remainder of the plurality of very high throughput long training fields and the data field. As can be seen from FIG. 4, the format of the streams shown in FIG. 4 is different from that of the streams shown in FIG. 2. The plurality of the fourth streams can be divided into several groups, wherein each group pertains to a receiving station. Accordingly, each of the fourth streams pertaining to the same receiving station has the same length. The very high throughput short training field and the plurality of very high throughput long training fields are used for channel estimation. For a full estimation of the channels of the MU-MIMO system, the number of the very high throughput long training fields of a plurality of fourth streams in a group is equal to or greater than the number of the antennas of the receiving station to which the group pertains. Since in this embodiment, there are three antennas for station A, the number of very high throughput long training fields pertaining to station A is four. Similarly, since there are two antennas for station A, the number of very high throughput long training fields pertaining to station B is two. The second very high throughput signal field contains information of the corresponding receiving stations. In other words, VHT-SIGₐ contains information of station A, and VHT-SIG_{b} contains information of station B.

Referring to the method shown in FIG. 3, when the transmitter uses the stream format shown in FIG. 4 to transmit data, cyclic shift operations are first performed for each of the first streams as indicated in step 301, wherein each of the first streams corresponds to a different cyclic shift value. Thereafter, the plurality of first streams are mapped to the antennas at the transmitter as indicated in step 302. Accordingly, the number of first streams is equal to the number of the antennas of the receiving stations. In step 303, the plurality of first streams are transmitted to a plurality of receiving stations. In some embodiments of the present invention, the bandwidth of the first streams can be 20 MHz, 40 MHz, 60 MHz or 80 MHz. If such bandwidth is wider than 20 MHz, the spectrum of each of the first streams is divided into sub-bands of 20 MHz, and each sub-band is a duplicate of other sub-bands with phase rotation.

In step 304, cyclic shift operations are first performed for each of the fourth streams, wherein each of the fourth streams in a group corresponds to a different cyclic shift value. However, the fourth streams in different groups may have the same cyclic shift value. In step 305, a plurality of spatial mapping operations are performed for each group of the plurality of fourth streams such that the plurality of fourth streams are modulated in a space division multiplexing manner. Accordingly, a beam-forming technique is utilized such that the antennas in station A can only receive the three data fields Data_{—l a1, Data}_a2 and Data_a3. Likewise, the antennas in station B can only receive the two data fields Data_b1 and Data_b2. In some embodiments of the present invention, the number of fourth streams is equal to or less than the number of the antennas of the transmitter. Accordingly, the parameter j of the very high throughput long training fields (VHT-LTF) shown in FIG. 4 for station A is less than three. Accordingly, the parameter j of the very high throughput long training fields (VHT-LTF) shown in FIG. 4 for station B is less than two. In step 106, the plurality of fourth streams are transmitted to the plurality of receiving stations. In some embodiments of the present invention, the bandwidth of the fourth streams can be 20 MHz, 40 MHz, 60 MHz or 80 MHz, and can be contiguous or non-contiguous. In the case of 80 MHz bandwidth, the very high throughput short training field is the 80 MHz version of the legacy short training field.

According to the aforementioned embodiments, cyclic shift operations are performed on the streams before transmission. In addition, cyclic shift operations can be performed in the frequency domain or in the time domain.

In conclusion, the present invention provides a communication method for a MIMO communication system, wherein the format of the transmitted streams comprises a plurality of first streams and a plurality of second streams. The plurality of first streams contain legacy fields, and accordingly, the transmitted streams are backward compatible with the present IEEE standard 802.11a/g/n. In addition, the plurality of second streams allow for the transmitted streams to be applied to a MU-MIMO system.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A communication method for a multiple-input-multiple-output (MIMO) communication system, comprising the steps of:
transmitting a plurality of first streams modulated in a non space division multiplexing manner from a transmitter to a plurality of receiving stations; and
transmitting a plurality of second streams following the plurality of first streams modulated in a space division multiplexing manner from the transmitter to the plurality of receiving stations;
wherein each of the first streams comprises a legacy short training field, a legacy long training field, a legacy signal field and at least a very high throughput signal field, and each of the first streams has the same length;
wherein each of the second streams comprises a very high throughput short training field, a plurality of very high throughput long training fields and a data field, and each of the second streams has the same length.

2. The communication method of claim 1, further comprising the step of:
performing cyclic shift operations for the plurality of first streams, wherein each of the first streams corresponds to a different cyclic shift value;
performing cyclic shift operations for the plurality of second streams, wherein each of the second streams corresponds to a different cyclic shift value; and
performing a spatial mapping operation for the plurality of second streams after the cyclic shift operations.

3. The communication method of claim 1, wherein the number of the very high throughput long training fields is equal to or greater than the number of the second streams.

4. The communication method of claim 1, wherein the format of each of the first streams follows the order of the legacy short training field, the legacy long training field, the legacy signal field and the at least one very high throughput signal field.

5. The communication method of claim 1, wherein the format of each of the second streams follows the order of the very high throughput short training field, the plurality of very high throughput long training fields and the data field.

6. The communication method of claim 1, wherein the number of first streams is equal to the number of the antennas of the transmitter.

7. The communication method of claim 1, wherein the number of second streams is equal to or less than the number of the antennas of the transmitter.

8. The communication method of claim 1, wherein the bandwidth of the communication method is 20 MHz, 40 MHz, 60 MHz or 80 MHz.

9. The communication method of claim 1, wherein the spectrum for the first streams is divided into sub-bands of 20 MHz, and each sub-band is a duplicate of other sub-bands with phase rotation.

10. A communication method for a multiple-input-multiple-output (MIMO) communication system, comprising the steps of:
transmitting a plurality of first streams modulated in a non space division multiplexing manner from a transmitter to a plurality of receiving stations; and
transmitting a plurality of second streams following the plurality of first streams modulated in a space division multiplexing manner from the transmitter to the plurality of receiving stations;
wherein each of the first streams comprises a legacy short training field, a legacy long training field, a legacy signal field and at least a first very high throughput signal field, and each of the first streams has the same length;
wherein each of the second streams comprises a very high throughput short training field, a plurality of very high throughput long training fields, a second very high throughput signal field and a data field, and each of the second streams pertaining to the same receiving station has the same length.

11. The communication method of claim 10, further comprising the step of:
performing cyclic shift operations for the plurality of first streams, wherein each of the first streams corresponds to different cyclic shift value;
performing cyclic shift operations for the plurality of second streams, wherein each of the second streams pertaining to the same receiving station corresponds to different cyclic shift value; and
performing a plurality of spatial mapping operations for the plurality of second streams after the cyclic shift operations.

12. The communication method of claim 10, wherein the number of the very high throughput long training fields of each of the second streams pertaining to the same receiving station is equal to or greater than the number of the second streams pertaining to that receiving station.

13. The communication method of claim 10, wherein the format of each of the first streams follows the order of the legacy short training field, the legacy long training field, the legacy signal field and the at least one first very high throughput signal field.

14. The communication method of claim 10, wherein the format of each of the second streams follows the order of the very high throughput short training field, the plurality of very high throughput long training fields, the second very high throughput signal field and the data field.

15. The communication method of claim 10, wherein the format of each of the second streams follows the order of the very high throughput short training field, the first field of the plurality of very high throughput long training fields, the second very high throughput signal field, the remainder of the plurality of very high throughput long training fields and the data field.

16. The communication method of claim 10, wherein the second very high throughput signal field of a second stream contains information to corresponding to the receiving station the second stream pertaining to.

17. The communication method of claim 10, wherein the number of first streams is equal to the number of the antennas of the transmitter.

18. The communication method of claim 10, wherein the number of second streams is equal to or less than the number of the antennas of the transmitter.

19. The communication method of claim 10, wherein the bandwidth of the communication method is 20 MHz, 40 MHz, 60 MHz or 80 MHz.

20. The communication method of claim 10, wherein the spectrum for the first streams is divided into sub-bands of 20 MHz, and each sub-band is a duplicate of other sub-bands with phase rotation.
